(19) United States
(12) Patent Application Publication
(10) Pub. No.: US 2013/0244631 A1
(43) Pub. Date: Sep. 19, 2013

(54) SYSTEMS AND METHODS FOR GENERATING A SHORTENED NOTIFICATION OF AN INCOMING CALL

(71) Applicant: Devika Phutane, Bangalore Karnataka (IN)

(72) Inventor: Devika Phutane, Bangalore Karnataka (IN)

(21) Appl. No.: 13/989,168

(22) PCT Filed: Mar. 30, 2011
(86) PCT No.: PCT/US11/30564

§ 371 Date: May 23, 2013

(51) Int. Cl. H04W 4/16

(52) U.S. Cl. CPC H04W 4/16
USPC 455/414.1

(57) ABSTRACT

Systems and methods for call management in a telecommunication network are described herein. An incoming call is received by a mobile device. A user of the mobile device is a subscriber of a provider of the telecommunication network. It is determined that a Do Not Disturb feature is activated. A notification of the incoming call is generated with a shortened duration.

### I. BACKGROUND

Wireless communications networks, also known as mobile telecommunications networks, have been widely adopted around the world. In a mobile telecommunications network, such as the Global System for Mobile communications (GSM), incoming calls are routed to mobile subscribers as soon as a calling telecommunications subscriber dials the directory number of a called mobile subscriber. The number dialed to reach a mobile subscriber is called the Mobile Subscriber Integrated Services Digital Network (MSISDN). This number includes a country code and a national destination code, which identifies the subscriber's operator. Furthermore, it includes a subscriber number identifying the subscriber. The MSISDN may also identify the subscriber's Home Location Register (HLR) within the Home Public Land Mobile Network (HPLMN). An HLR is a database that contains information about subscribers to a mobile network. The HLR registers subscribers for a particular service provider. Rather than temporary subscriber data, which is managed by a Visited Location Register (VLR), the HLR stores “permanent” subscriber information including the service profile, and a VLR address associated to the subscriber.

A call to a mobile device is called a mobile terminated call in GSM. An incoming request for setting up a mobile terminated call is directed to a Mobile Switching Center (MSC). The MSC routes the call to the MSC that is currently able to reach the called mobile subscriber. The device of the called mobile subscriber is then paged in its current location area.

The call to the mobile subscriber is attempted by the provider of the telecommunication service until, for example, the call is completed (i.e., subscriber answers the call) or there is no answer for the duration of the service provider's call timeout period.

### II. BRIEF DESCRIPTION OF THE DRAWINGS

The present disclosure may be better understood and its numerous features and advantages made apparent to those skilled in the art by referencing the accompanying drawings.

FIG. 1 is a block diagram of an architecture of a mobile device in accordance with an embodiment.

FIG. 2 is a process flow diagram for call management in accordance with an embodiment.

FIG. 3A is a process flow diagram for determining the state of a mobile device in accordance with an embodiment.

FIG. 3B is a state diagram in accordance with an embodiment.

FIG. 4A is a process flow diagram for identification of missed calls with shortened notifications in accordance with an embodiment.

FIG. 4B is a user interface on a mobile device in accordance with an embodiment.

FIG. 5 illustrates a computer system in which an embodiment may be implemented.

### III. DETAILED DESCRIPTION

When an incoming call is routed to a mobile device of a subscriber, the call is typically attempted by the service provider for the duration of the timeout period. If the call has not been answered during this period, the call may be forwarded to a voicemail service.

Safety concerns have arisen over the use of mobile devices, such as while driving and making a call, conversing, etc. An elaborate ringing or other notification of an incoming call while driving or being otherwise occupied may pose an additional safety risk. For example, a ring or alert that continues for 15 seconds or more is sufficient to cause distraction to the callee who may be driving a vehicle, thus making the callee more prone to accidents.

Methods for call management in a telecommunication network are described herein. An incoming call is detected by a mobile device. A user of the mobile device is a subscriber of a provider of the telecommunication network. It is determined whether a Do Not Disturb feature is activated. A notification identifier corresponding to the incoming call is also determined. A call notification using the notification identifier is generated where the Do Not Disturb feature is activated. A duration of the call notification is shortened.

Furthermore, methods and systems for call management in a telecommunication network are described herein. The system includes a radio transceiver to receive a first incoming call and a global positioning system to receive location information of the mobile device. A user of the mobile device is a subscriber of a provider of the telecommunication network. The system also includes a call management system which determines that a speed of the mobile device exceeds a minimum speed threshold for an activation time period, based on the location information. A Do Not Disturb feature is activated, and a notification of the first incoming call is generated with a shortened duration upon determining the Do Not Disturb feature is activated. The shortened duration is less than a call timeout period of the provider.

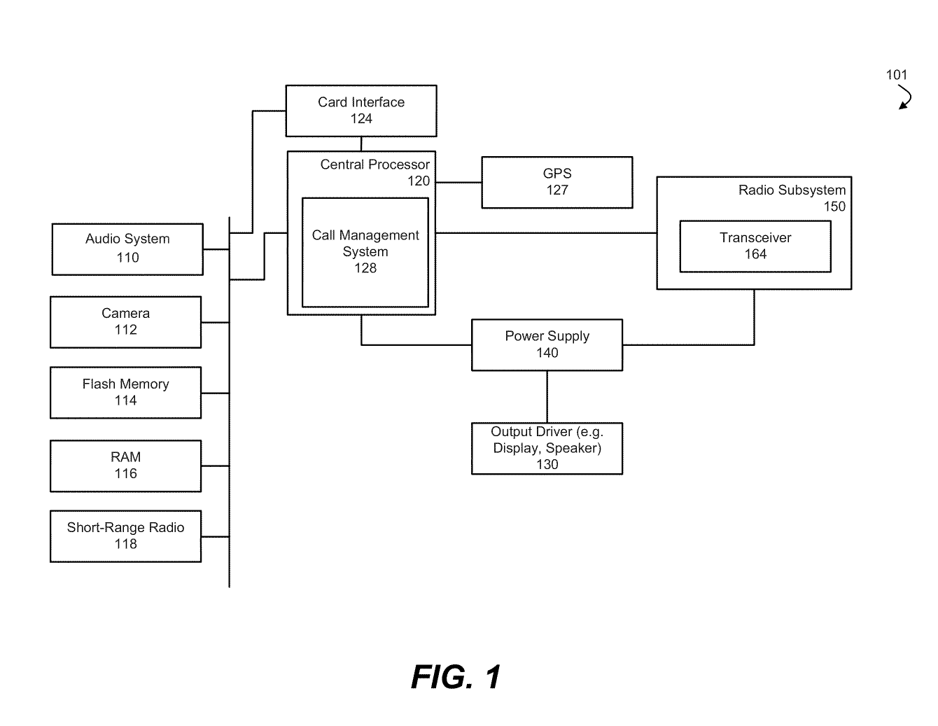

FIG. 1 is a block diagram of an architecture of a mobile device 101 with telephonic functionality, in accordance with an embodiment. Mobile device 101 includes a central processor 120, a power supply 140, and a radio subsystem 150. The central processor 120 communicates with: audio system 110, camera 112, flash memory 114, RAM memory 116, short range radio module 118 (e.g., Bluetooth, Wireless Fidelity (Wi-Fi) component), a global positioning system (GPS) module 127, a card interface 124, and radio subsystem 150. The power supply 140 powers central processor 120, radio subsystem module 150, and output device drivers 130, for example, a display driver (which may be contact- or inductive-sensitive) and/or an audio driver (which may include volume control in addition to speaker output). Power supply 140 may correspond to a battery pack (e.g., rechargeable) or a power line connection or component.

Radio subsystem 150 includes a transceiver 164. Transceiver 164 may be two separate components for transmitting and receiving signals or a single component for both transmitting and receiving signals. In either instance, it is referenced as transceiver 164. The receiver portion of the transceiver 164 communicatively couples with a radio signal input of device 101, e.g., an antenna, where communication signals are received for a call. The call may be an incoming call or an established call (e.g., a connected, on-going call, or active call). The received communication signals include paging messages sent by a base station for an incoming call, data messages and/or control signals which orders mobile device 101 to ring or provide other audio, visual, or physical (e.g., vibration) indication of an incoming call. When a call is established, the received communication signals may include voice (or other sound signals) received from the call The communication signals, whether received before or after a call is established, is processed by central processor 120 for output through a speaker for example operatively coupled to output driver 130.

The transmitter portion of transceiver 164 communicatively couples a radio signal output of device 101 (e.g., the antenna, where communication signals are transmitted) to a call or data communication. The communication signals for transmission include data or voice, e.g., received through a microphone, for example of audio system 110, (or other sound signals) that are processed by central processor 120 for transmission through the transmitter of transceiver 164 to the call.

In one embodiment, communications using the described radio communications may be over a voice or data network. Examples of voice networks include Global System of Mobile (GSM) communication system, a Code Division, Multiple Access (CDMA system), and a Universal Mobile Telecommunications System (UMTS). Examples of data networks include General Packet Radio Service (GPRS), third-generation (3G) mobile, fourth-generation (4G) mobile, High Speed Download Packet Access (HSDPA), High Speed Uplink Packet Access (HSUPA), and Worldwide Interoperability for Microwave Access (WiMAX).

While other components may be provided within radio subsystem 150, the basic components shown provide the ability for the mobile device to perform radio-frequency communications, including telephonic communications. In an embodiment, many, if not all, of the components under the control of the central processor 120 are not required when a telephone call is incoming or established.

Card interface 124 is adapted to communicate with an expansion slot. Card interface 124 transmits data and/or instructions between central processor 120 and an expansion card or media card included in the expansion slot. Card interface 124 also transmits control signals from central processor 120 to the expansion slot to configure an expansion card or media card included in the expansion slot.

Global positioning system (GPS) 127 is a hardware, software and/or firmware module that includes instructions for receiving (or retrieving or accessing) location (or position) data corresponding to device 101. This location information may be derived from received GPS signals. It is noted that the device can be configured to leverage other technology as a substitute or in addition to the GPS information to determine location of the device. For example, signals from 802.11 (or Wi-Fi) networks or cellular networks can be used to triangulate (e.g., cellular tower triangulation) to determine the geographical position.

Central processor 120 includes a call management system 128, which is comprised of a module(s) of software and/or firmware that includes instructions to control (or adjust) call mechanisms within mobile device 101 based on a determination that mobile communication device 101 is in motion or in transport. Examples of how call mechanisms can be controlled include reducing a notification cycle to the caller and reducing the duration of an audio, visual, or physical notification of an incoming call. For example, the duration for which the device rings, vibrates, and/or illuminates may be controlled by being reduced or shortened, but not eliminated.

It is noted that call management system 128 is configured to interface with GPS 127 and applications, such as a phone application or messaging application. In turn, these applications may interface with the radio subsystem, for example, to receive incoming telephone calls, incoming short message service (SMS), electronic mail messages.

The module(s) of central processor 120 further include instructions to determine a speed of the mobile device, determine a state of the mobile device based on the speed, activate or inactivate a Do Not Disturb feature, and generate a notification of an incoming call with a shortened duration where the Do Not Disturb feature is activated. Furthermore, the module(s) of central processor 120 include instructions to play an announcement to the caller about the callee's driving status.

It is noted that numerous other components and variations are possible to the hardware architecture of mobile device 101, thus an embodiment such as shown by FIG. 1 is just illustrative of one implementation for an embodiment.

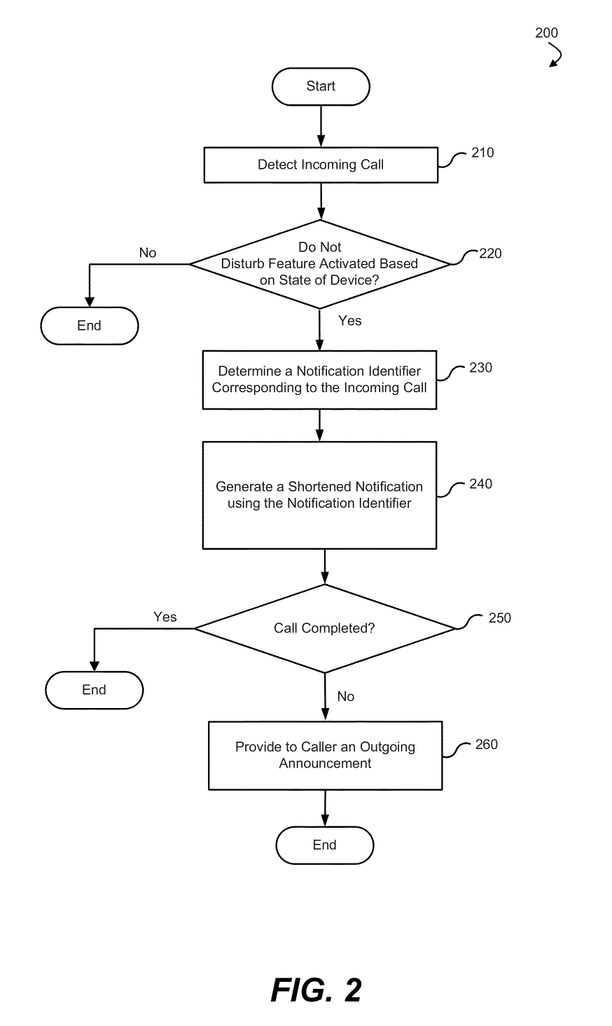

FIG. 2 is a process flow diagram for call management in accordance with an embodiment. The depicted process flow 200 may be carried out by execution of sequences of executable instructions. In another embodiment, various portions of the process flow 200 are carried out by components of a mobile device, components of a mobile service provider platform, an arrangement of hardware logic, e.g., an Application-Specific Integrated Circuit (ASIC), etc. For example, blocks of process flow 200 may be performed by execution of sequences of executable instructions in a call management system of the mobile device.

At step 210, the mobile device detects an incoming call. When a call is made to a user of a mobile device, a mobile switching center (MSC) in a wireless communication network carries out the call request to a base station in the network. A paging message is sent from a base station and is received by the mobile device. An acknowledgement message is sent by the mobile device to the base station. After this handshake, the base station signals the mobile device to notify the user of the incoming call, for example by ringing.

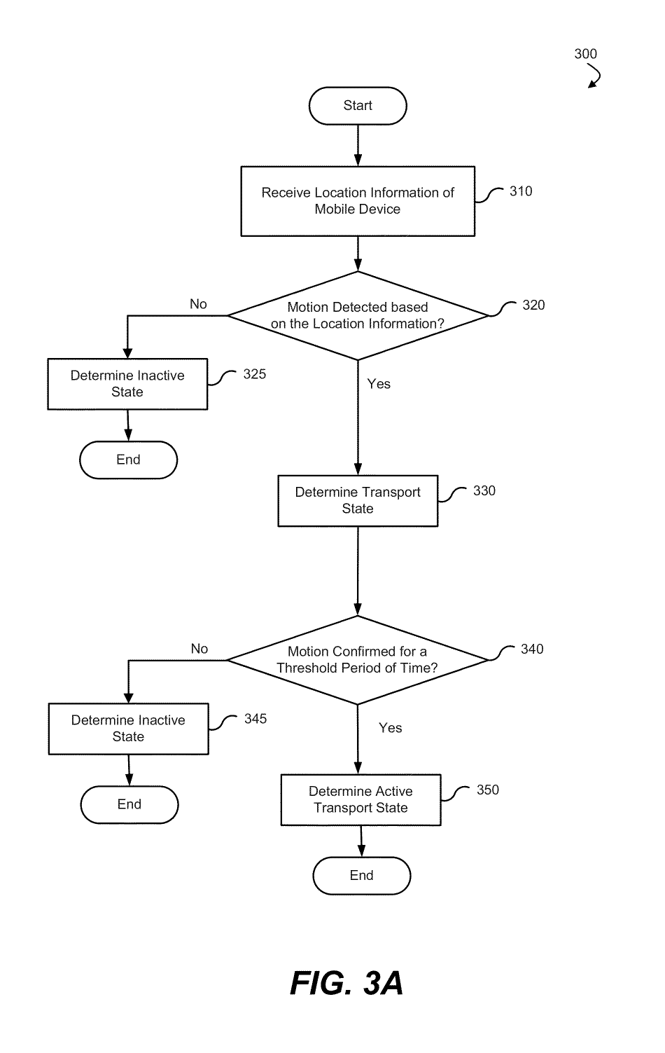

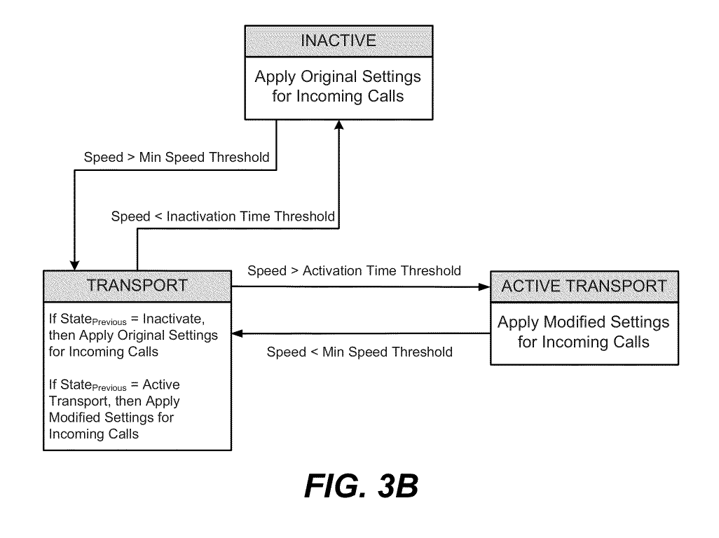

At step 220, it is determined whether a Do Not Disturb (DND) feature has been activated based on a state of the mobile device. As used herein, the DND feature produces a call notification (e.g., ring, vibrate, visual flashing, etc.) with a shortened duration of time. Specifically, the notification of an incoming call to a user of the mobile device is shortened, but is not disabled. The DND feature is activated where the slate of the mobile device is in an active transport state or is in a transport state when the previous state was the active transport state. The states of the mobile devices are further described in FIGS. 3A and 3B. Where it is determined that the DND feature is not activated, processing ends.

Where it is determined that the MD feature is activated, a notification identifier corresponding to the incoming call is determined at step 230. The notification identifier includes an identification of a default ring tone, a specialized ring tone associated with the caller, or other default or specialized alert corresponding to the incoming call. For example, a specialized ring tone may be assigned to a contact in a contact list of the user's mobile device. Where no specialized ring tones are set, a default ring tone may be used. Each ring tone, whether default or specialized) is associated with a unique identifier. Other alerts instead of or in addition to a ring tone may also be determined. For example, the mobile device may be set to vibrate in addition to outputting a ring tone for an incoming call. An identifier for a specialized or default alert that corresponds to the incoming call is determined.

At step 240, a notification is generated using the notification identifier. Moreover, the duration of the generated notification is shortened, but not disabled. In other words, the mobile device outputs a shortened version of a typical call notification. Normally, the mobile device ring for the entire duration of the service provider's timeout period (e.g., 20 seconds). As described herein, the mobile device may ring for a time period that is less than the service provider's timeout period (e.g., 5 seconds) or may be activated for two ring cycles, instead of the typical 5 ring cycles. As such, the user is still made aware of the incoming call but the notification does not disturb or otherwise overwhelm the user while driving. By generating the shortened notification using the notification identifier, any specialized ring tone or alert corresponding to the incoming call is preserved. The amount of time that the shortened notification is carried out is configurable.

Where the incoming call corresponds with multiple types of notifications (e.g., audio, visual, and physical), the duration of any type of notification may be shortened. For example, if a notification of an incoming call typically occurs via a default ring tone and a vibration, the shortened notification may reduce the duration of the ring tone and/or the vibration. In one embodiment, determining which type of call notification to shorten is fully configurable.

At step 250, it is determined whether the call has been completed. As used herein, a call is completed when the user answers the incoming call. If the call is completed, no outgoing message is provided. If the call has not been completed, the outgoing message is provided to the caller at step 260. The outgoing announcement may inform the caller that the user of the mobile device is driving or otherwise occupied.

In one embodiment, if the call is not completed during the service provider's timeout period, the incoming call is redirected to a voicemail service or an announcement server on the service provider's network of the called party. When the call is forwarded or redirected, the mobile device may provide to the service provider state information about the device or other information indicating the DND feature is activated. The service provider may then provide to the caller an outgoing announcement that indicates that the user is driving or otherwise occupied. The outgoing announcement may be configurable, for example by the user.

In another embodiment, an audio file of the outgoing announcement is maintained by the mobile device. Upon determining that the call is incomplete, for example after the expiration of the service provider's timeout period or another timeout period, the mobile phone provides the outgoing announcement to the caller. The call may then be forwarded to the voicemail service.

Furthermore, if the mobile device receives an incoming text message while the DND feature is activated, a shortened notification corresponding to the incoming text message may be generated. At any time, the DND feature may be manually disabled or enabled. For example, the DND feature would not be useful in a scenario where the user of the mobile device is riding as a passenger of a private vehicle or a mass transit vehicle. As such, the user of the mobile device may disable the feature. Even if not disabled, the DND feature reduces the duration of call notifications, but does not disable incoming calls. The user is not deprived of the opportunity to answer a call.

In one embodiment, when the mobile device detects a state change in itself, these state changes may be communicated to the service provider. For example, when the mobile device detects a state in which the DND feature is active, the state information is provided to the service provider. Upon receiving such information, the service provider may adjust (e.g., reduce) the timeout period. As such, notifications of further incoming calls may be shortened since the service provider's timeout period is shortened.

FIG. 3A is a process flow diagram for determining the state of a mobile device in accordance with an embodiment. The depicted process flow 300 may be carried out by execution of sequences of executable instructions. In another embodiment, various portions of the process flow 300 are carried out by components of a mobile device, components of a mobile service provider platform, an arrangement of hardware logic, e.g., an Application-Specific Integrated Circuit (ASIC), etc. For example, blocks of process flow 300 may be performed by execution of sequences of executable instructions in a call management system of the mobile device.

As described herein, the duration of a notification (e.g., audio, visual, physical) of an incoming call is shortened based on a status of the mobile device. At step 310, location information of a mobile device is determined. The location information includes geographic coordinates that identify a geographic location of the mobile device. The geographic coordinates may include latitude, longitude, orbital information, etc.

The geographic coordinates can be determined in various manners. In one embodiment, a GPS receiver integrated with or coupled to the mobile device may determine the physical location of the mobile device using data in messages transmitted by satellites. A triangulation methodology may also be used to determine the physical location or position, for example by measuring the relative position of the mobile device against reference points with known geographic positions, such as cellular transmission towers. Furthermore, the geographic coordinates can be determined by a Wi-Fi network with a known geographic position. Other methods of determining the geographic coordinates may be implemented.

At step 320, it is determined whether the mobile device is in motion based on the location information. For example, the speed of the mobile device may be determined using the location information, or through other techniques, such as using the number of handoffs of a call between base stations. When the speed of the mobile device meets or exceeds a minimum speed threshold, it may be determined that the device and its user are in motion. The speed of the mobile device may be determined by components of the mobile device, a network element in a wireless telecommunications network, or any combination thereof.

The minimum speed threshold may be set to any speed at which it may be assumed that the device is in a moving vehicle. In another embodiment, the minimum speed threshold is set to any speed at which it is assumed that repeated rings or other notifications of an incoming call pose a safety risk for the user of the mobile device. For example, the minimum speed threshold is set to 25 miles per hour. At this speed, it is assumed the device is in a moving vehicle. Driving in excess of such speed threshold and possibly receiving repeated rings is hazardous for the user of the device. The minimal speed may be configurable by the user of the mobile device. In one embodiment, the minimal speed threshold is expressed as a range of speeds.

Where motion is not detected, it is determined that the mobile device is in an inactive state, at step 325. When the device is in an inactive state, reduction in the duration of the call notification (e.g., ring, vibrate, visual flashing, etc.) may not be performed.

However, where motion is detected, it is determined that the mobile device is in a transport state at step 330. In one embodiment, before any modifications or restrictions are put into effect, at step 340, it is confirmed that the mobile device is in motion for a threshold period of time (i.e., activation time threshold). Confirming the motion may lessen the likelihood of prematurely activating a Do Not Disturb (DND) feature and/or toggling between activating and inactivating the DND feature. When the DND feature is active, the duration of a call notification is reduced by a configurable amount and/or a shortened call notification is generated.

For example, the speed associated with the mobile device may fluctuate for any time period. The fluctuations may rise above the minimum speed threshold and may precipitously fall below the minimum speed threshold, as commonly occurs during city driving. Without the transport state, the DND feature would be activated whenever the speed exceeds the minimum speed threshold, and would be made inactive whenever the speed falls below the minimum speed threshold, which could cause repeated toggling.

Using the transport state, the DND feature is activated where the speed exceeds the minimum speed threshold for an activation time period (i.e., activation time threshold). Moreover, the DND feature is made inactive where the speed falls below the minimum speed threshold for an inactivation time period (i.e., inactivation time threshold). The inactivation time period and activation time period serve as a confirmation before implementing a change with the DND feature.

It is determined that the mobile device is in an inactive state at step 345, and a reduction in the duration of the call notification (e.g., ring, vibrate, visual flashing, etc.) may not be performed. To illustrate, the mobile device's speed may momentarily exceed the minimum speed threshold. The speed then proceeds to a halt, such as what would occur where the user is waiting at a stop light or stop sign. The DND feature is not activated since the user is not in a dangerous driving condition, and as such, would not be negatively affected by the original notification (e.g., full duration) for an incoming call.

On the other hand, where the motion is confirmed for the time threshold, it is determined that the mobile device is in an active transport state at step 350. In this state, a Do Not Disturb (DND) feature is activated, whereby the duration of the call notification is reduced by a configurable amount and a shortened call notification is generated, for example, as previously described in step 240 of FIG. 2.

FIG. 3B is a state diagram in accordance with an embodiment. As described herein, a shortened call notification is provided to a user of a mobile device based on the state of the mobile device. In one embodiment, the process of determining a current state and activating or inactivating a DND feature may be performed by a call management module of a mobile computing device, and may occur independently from and/or simultaneously with generation of the shortened notification.

As described herein, the mobile device may be in one of three distinct states at any time. In an inactive state, the original settings for incoming calls are applied. In this state, the DND feature is deactivated (i.e., removed from a previously active status) or the DND feature is otherwise rendered inactive. For example, the notification of an incoming call is not modified. In a transport state, the original settings for incoming calls are applied if the previous state was the inactive state. On the other hand, modified settings for incoming calls are applied if the previous state was an active transport state. In the active transport state, the modified settings for incoming calls are applied. As used herein, the modified settings include settings that cause the duration of the notification to be shortened.

As previously described, the speed of the mobile device may fluctuate and rise above the minimum speed threshold and fall below the minimum speed threshold, as is likely to occur in typical city traffic. The transport state serves a purpose to avoid repeated toggling between activating and deactivating the DND feature. In this state, the action of the previous state is held until there is consistency with respect to the speed for some time period, i.e., an inactivation time threshold or activation time threshold.

The transition from the inactive state to the transport state occurs when the speed of the mobile device exceeds a minimum speed threshold. The transition from the transport state to the inactive state occurs when the speed falls below the minimum speed threshold for a threshold time period, i.e., inactivation time threshold. If the DND feature was active, a transition from the transport state to the inactive state occurs when the speed falls below the minimum speed threshold for an inactivation time threshold. After the transition to the inactive state, the DND feature is deactivated.

The transition from the transport state to the active transport state occurs if the speed of the mobile device exceeds the minimum speed threshold for a threshold time period, i.e., activation time threshold. If the activation time threshold is reached, the state of the mobile device becomes the active transport state whereby the DND feature is activated.

The transition from the active transport state to the transport state occurs if the speed of the mobile device falls below the minimum speed threshold. For example, upon determining the mobile device is in the active transport state, after some period of time, it is determined whether the speed of the mobile device continues to exceed the minimum speed threshold. If the speed falls below the minimum speed threshold, the new state of the mobile device is the transport state.

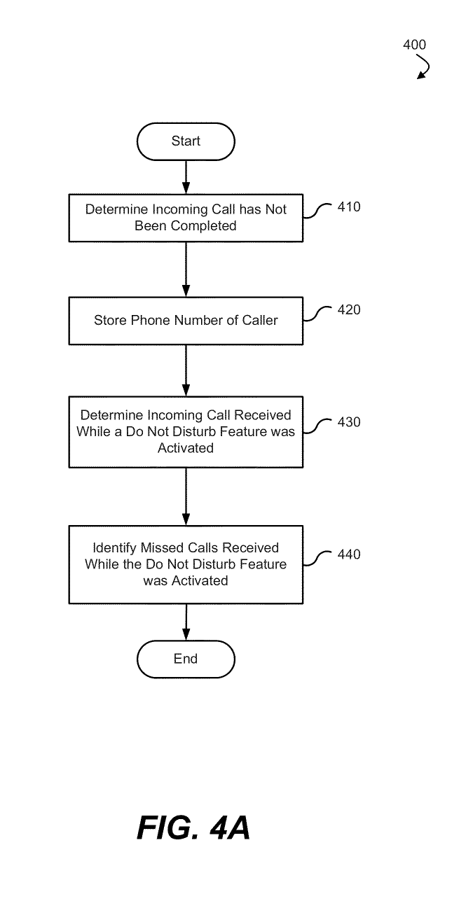

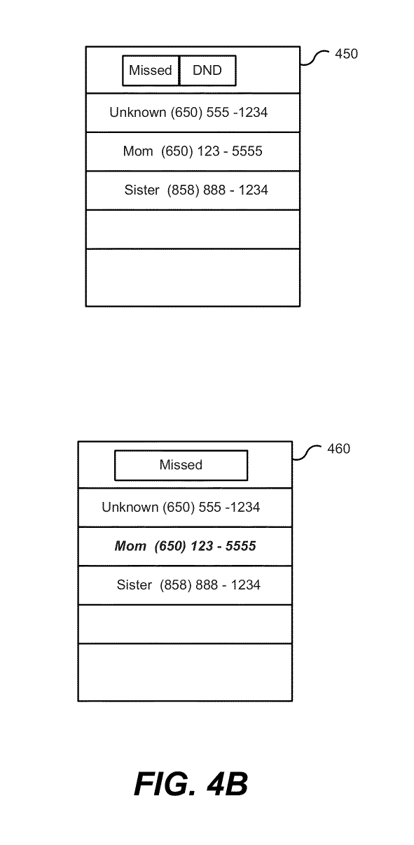

FIG. 4A is a process flow diagram for identification of missed calls with shortened notifications in accordance with an embodiment. The depicted process flow 400 may be carried out by execution of sequences of executable instructions. In another embodiment, various portions of the process flow 400 are carried out by components of a mobile device, components of a mobile service provider platform, an arrangement of hardware logic, e.g., an Application-Specific Integrated Circuit (ASIC), etc, For example, blocks of process flow 400 may be performed by execution of sequences of executable instructions in a call management system of the mobile device.

At step 410, it is determined that an incoming call has not been completed, e.g., a user of the mobile device has not answered the call. The phone number of the caller is stored, for example in a memory of the mobile device at step 420. Other information of the caller may also be stored. At step 430, it is determined that the incoming call was received while a Do Not Disturb feature was activated. At step 440, calls that were received and not completed (i.e., missed calls for which an announcement may have been played to the caller about the callee's driving status after the shortened notification to the callee) while the Do Not Disturb feature was activated are identified to the user of the mobile device. For example, the identified calls are those that were missed while the mobile device was in the active transport state, or in the transport state where the previous state was the active transport state.

FIG. 4B is a user interface on a mobile device in accordance with an embodiment. In one embodiment, screen 450 identifies all missed calls received while a Do Not Disturb (DND) feature was active. As shown, all listed phone numbers were calls received and missed while the DND feature was active. Screen 460 is illustrative of another embodiment, whereby all missed calls are listed. The missed calls received while the DND feature was active are identified in a distinguishing manner. For example, in screen 460, the “Mom” entry is a missed call received while the DND feature was active, and is identified using italics and boldface.

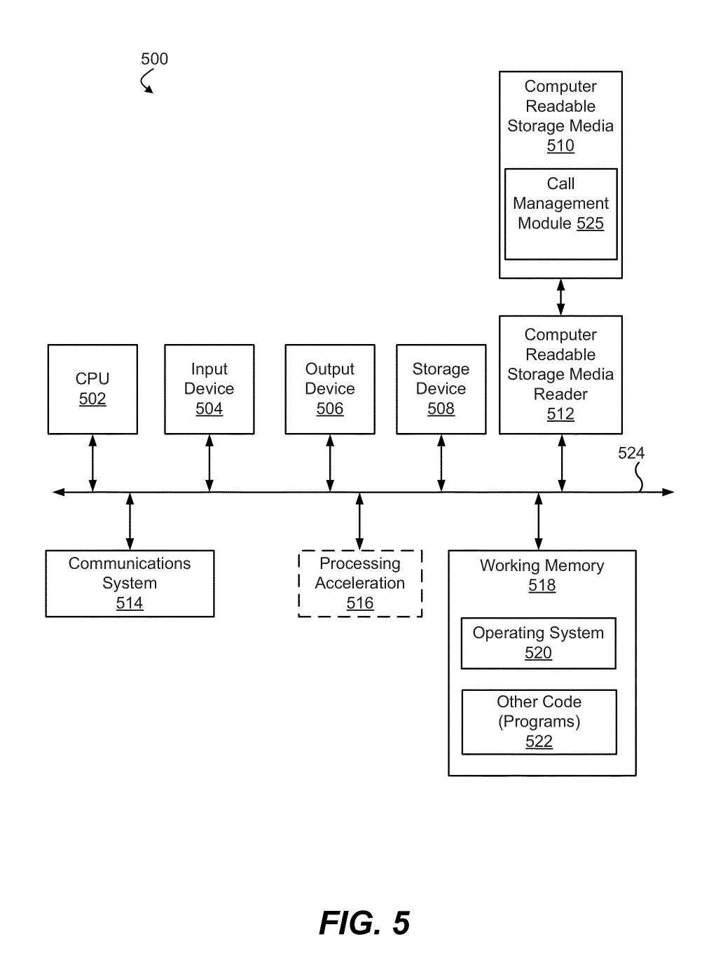

FIG. 5 illustrates a computer system in which an embodiment may be implemented. The system 500 may be used to implement any of the computer systems described above. The computer system 500 is shown comprising hardware elements that may be electrically coupled via a bus 524. The hardware elements may include at least one central processing unit (CPU) 502, at least one input device 504, and at least one output device 506. The computer system 500 may also include at least one storage device 508. By way of example, the storage device 508 can include devices such as disk drives, optical storage devices, solid-state storage device such as a random access memory (“RAM”) and/or a read-only memory (“ROM”), which can be programmable, flash-updateable and/or the like.

The computer system 500 may additionally include a computer-readable storage media reader 512, a communications system 514 (e.g., a modem, a network card (wireless or wired), an infra-red communication device, etc.), and working memory 518, which may include RAM and ROM devices as described above. In some embodiments, the computer system 500 may also include a processing acceleration unit 516, which can include a digital signal processor (DSP), a special-purpose processor, and/or the like.

The computer-readable storage media reader 512 can further be connected to a computer-readable storage medium 510, together (and in combination with storage device 508 in one embodiment) comprehensively representing remote, local, fixed, and/or removable storage devices plus any tangible non-transitory storage media, for temporarily and/or more permanently containing, storing, transmitting, and retrieving computer-readable information (e.g., instructions and data). Computer-readable storage medium 510 may be non-transitory such as hardware storage devices (e.g., RAM, ROM, EPROM (erasable programmable ROM), EEPROM (electrically erasable programmable ROM), hard drives, and flash memory). The communications system 514 may permit data to be exchanged with the network and/or any other computer described above with respect to the system 500. Computer-readable storage medium 510 includes a call management module 525.

The computer system 500 may also comprise software elements, which are machine readable instructions, shown as being currently located within a working memory 518, including an operating system 520 and/or other code 522, such as an application program (which may be a client application, Web browser, mid-tier application, etc.). It should be appreciated that alternate embodiments of a computer system 500 may have numerous variations from that described above. For example, customized hardware might also be used and/or particular elements might be implemented in hardware, software (including portable software, such as applets), or both. Further, connection to other computing devices such as network input/output devices may be employed.

The specification and drawings are, accordingly, to be regarded in an illustrative rather than a restrictive sense. It will, however, be evident that various modifications and changes may be made.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example of a generic series of equivalent or similar features.

What is claimed is:

1. A method for call management in a telecommunication network, the method comprising:
detecting, by a mobile device, an incoming call, wherein a user of he mobile device is a subscriber of a provider of the telecommunication network;
determining whether a Do Not Disturb feature is activated;
determining a notification identifier corresponding to the incoming call; and
generating a call notification using the notification identifier where the Do Not Disturb feature is activated, wherein a duration of the call notification is shortened.

2. The method of claim 1, wherein the Do Not Disturb feature is activated where a speed of the mobile device exceeds the minimum speed threshold for an activation time period.

3. The method of claim 1, wherein the Do Not Disturb feature is activated where a current speed of the mobile device exceeds the minimum speed threshold and a preceding speed of the mobile device exceeded the minimum speed threshold for an activation time period.

4. The method of claim 1, further comprising:
determining the incoming call has not been completed; and
providing to a requestor of the call an outgoing announcement after a call timeout period of the provider, wherein the outgoing announcement is customizable.

5. The method of claim 1, wherein the Do Not Disturb feature is deactivated where a speed of the mobile device is below the minimum speed threshold for an inactivation time period.

6. The method of claim 1, wherein the duration of the call notification is shorter than a call timeout period of the provider, and wherein the duration of the call notification is configurable.

7. The method of claim 1, further comprising: modifying a default call timeout period of the provider, wherein the duration of the call notification is based on the modified default timeout period.

8. A method for call management in a telecommunication network, the method comprising:
receiving, by a mobile device, location information of the mobile device, wherein a user of the mobile device is a subscriber of a provider of the telecommunication network;
determining a speed of the mobile device exceeds a minimum speed threshold for an activation time period, based on the location information;
activating a Do Not Disturb feature;
receiving a first incoming call; and
generating a notification of the first incoming call with a shortened duration upon determining the Do Not Disturb feature is activated, wherein the shortened duration is less than a call timeout period of the provider.

9. The method of claim 8, further comprising:
determining a current speed of the mobile device is below the minimum speed threshold;
detecting a second incoming call; and
generating a notification of the second incoming call with a shortened duration.

10. The method of claim 8, further comprising:
determining a current speed of the mobile device is below the minimum speed threshold for an inactivation time period;
deactivating the Do Not Disturb feature;
detecting a second incoming call; and
generating a notification of the second incoming call with a duration equal to the call timeout period of the provider upon determining the Do Not Disturb feature is not active.

11. The method of claim 8, further comprising:
determining the first incoming call has not been completed: and
providing to a requestor of the first call an outgoing announcement after a call timeout period of the provider.

12. A system for management of call notification mechanisms within a mobile computing device, the system comprising:
a radio transceiver configured to receive a first incoming call;
a global positioning system configured to receive location information of the mobile device;
a call management system configured to:
determine a speed of the mobile device exceeds a minimum speed threshold for an activation time period, based on the location information;
activate a Do Not Disturb feature; and
generate a notification of the first incoming call with a shortened duration upon determining the Do Not Disturb feature is activated, wherein the shortened duration is less than a call timeout period of the provider.

13. The system of claim 12, wherein the radio transceiver is configured to receive a second incoming call, and wherein the call management system is configured to:
determine a current speed of the mobile device is below the minimum speed threshold; and
generate a notification of the second incoming call with a shortened duration.

14. The system of claim 12, wherein the radio transceiver is configured to receive a second incoming call, and wherein the call management system is configured to:
determine a current speed of the mobile device is below the minimum speed threshold for an inactivation time period;
deactivate the Do Not Disturb feature; and
generate a notification of the second incoming call with a duration equal to the call timeout period of the provider upon determining the Do Not Disturb feature is not active.

15. The system of claim 12, wherein the notification of the first incoming call comprises at least one of an audible notification, a visual notification, and a physical notification.
